(19) United States
(12) Patent Application Publication
(10) Pub. No.: US 2005/0152362 A1
(43) Pub. Date: Jul. 14, 2005

(54) Data classification management system and method thereof

(76) Inventor: Yi-Chieh Wu, Taipei City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 11/024,681

(22) Filed: Dec. 30, 2004

Related U.S. Application Data
(63) Continuation of application No. 10/747,053, filed on Dec. 30, 2003.

(30) Foreign Application Priority Data
Jun. 18, 2004 (TW) 93117665

(51) Int. Cl. H04L 12/28

(52) U.S. Cl. 370/389; 707/1

(57) ABSTRACT

The present invention provides a data cluster classification management system. This system includes a management module, a grouping module, a construction module, a storage means and a user interface. The construction module generates a destination structure in a computer system. The grouping module selects data files in the destination structure to generate a cluster sequence. The management module manages the cluster sequence. A data structure related to a cluster sequence or destination structure may stored to a storage means. The user interface may respond to the action of the user and display the result. The method and system may provide a user the ability to directly merge or release related data.

### FIELD OF THE INVENTION

The present invention relates to a computer data classifying management system and method thereof, and more particularly, to a classifying management system and method thereof for managing cluster of data.

### BACKGROUND OF THE INVENTION

The data management functions provided by an operating system, such as Microsoft Windows, Apple Mac OS, Linux and so on, always include the file functions of copying, moving, renaming, deleting, searching, sorting and so on. Some operating systems, such as Windows XP, further provide a thumbnail browser model on the system level. However, those operating systems, and even other software applications providing a thumbnail browser model, do not provide an enhanced data classifying management method and system.

For example, when a user wants to build a destination (such as directory, folder, file, album or logic object and so on) for storing his favorite pictures, first the user has to create a destination and name it. Next, those pictures that he wants to store in this destination are selected. Then, a copy function is used to store those pictures in this destination. In other words, the foregoing reorganization process involves three steps, creating a destination, selecting pictures and storing pictures to the destination. Therefore, when the user's taste changes and he wants to group the pictures again, the user has to repeat the foregoing reorganization steps again. When the user has more and more pictures and wants to recast the classification of these pictures, the reorganization step has to be performed again and again, which is a great deal of work for the user.

As for the data management of the computer, no matter whether the data is at the system level or at the program application level, a specific destination has to be created for realizing the management and the classification of the data. At this time, the reorganization deals with renaming, moving, deleting and searching for this destination or renaming, deleting, searching for and sorting the data stored in the destination. Moreover, the reorganization may also involve copying, moving, renaming, deleting, searching for and sorting the data in two different destinations. This work is not only complex but also costs time. Any classification change requires performing complex work again and again, which causes the user to hesitate to re-classify the data and even give up grouping the data. It is difficult to find any related data when the data bank is full of unorganized data.

Accordingly, an improved classification method and system thereof is required.

### SUMMARY OF THE INVENTION

The main purpose of the present invention is to provide a data classification method and system for directly merging or releasing related data. It is not necessary to create a destination first for the method.

To obtain the foregoing purpose, the present invention provides a data cluster classification management system. This system includes a management module, a grouping module, a construction module, a storage means and a user interface. The construction module generates a destination structure in a computer system. The destination structure is selected as a destination that is related to a list, data file or logic object. The grouping module selects data in the corresponding list, data file or logic object to generate a cluster sequence. The storage means includes a cluster sequence file storing a data structure of a cluster sequence and a destination structure file storing a data structure of a destination structure. These data clusters are classified by the management module according to at least one cluster action and then, the content of the cluster sequence is renewed. The user interface may respond to the action of the user and display the result.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram of a preferred embodiment of the present invention;

FIG. 2A is a diagram of a cluster sequence file;

FIG. 2B is a diagram of a destination structure file;

FIG. 3 is a flow chart of a preferred embodiment of the present invention;

FIG. 4 is a diagram of a normal-mode user interface according to the embodiment of the present invention;

FIG. 5 is a diagram of a stack-mode user interface according to the embodiment of the present invention; and

FIG. 6 is a diagram of a user interface displayed by text according to the embodiment of the present invention.

### DETAILED DESCRIPTION OF THE PREFERRED EMBODIMENT

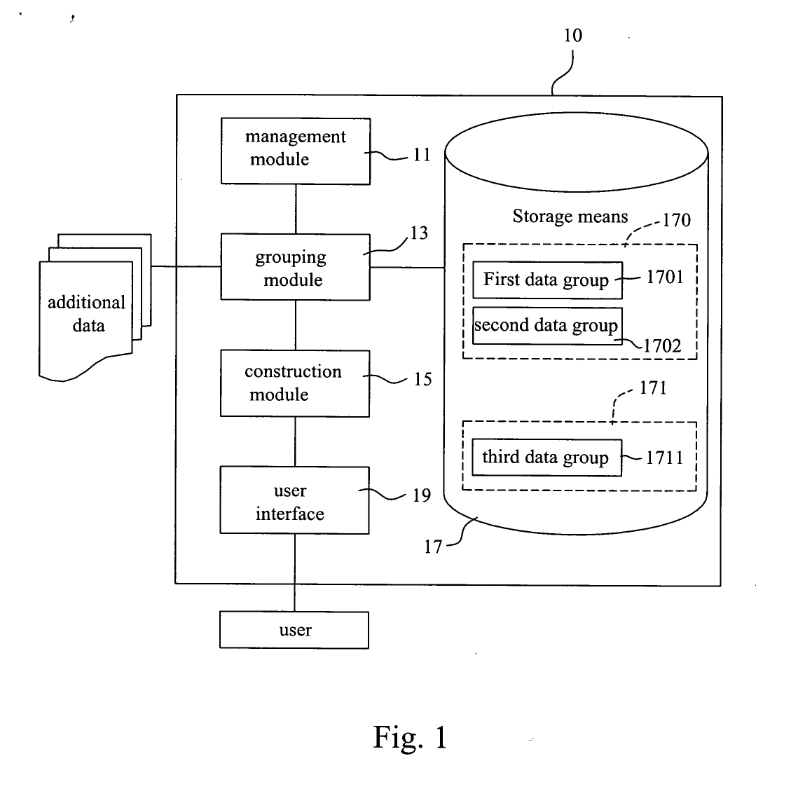

FIG. 1 illustrates a block diagram of the preferred embodiment of the present invention. The present invention is a computer data classification method and system thereof. The method of the present invention can directly merge data to form a cluster. In other words, it is not necessary to form a destination in the present invention. The cluster in the present invention is a data set that is composed of one datum or many data. The cluster set is a cluster sequence.

The classification management system of the embodiment includes a management module 11, a grouping module 13, a construction module 15, a storage means 17 and a user interface 19. In the present invention, a user may input instructions through the user interface 19 to classify and manage the data stored in the computer.

The construction module 15 may generate a destination structure with a tree structure. A destination can be selected from the destination structure. This destination may be a list or a data file in a computer system. In accordance with the embodiment, the destination is set in a predetermined list (such as the root list of the C-disk) or the list last used. When a user uses a cursor or a keyboard to select a different destination, a corresponding list is generated. At this time, the grouping module 13 can select data from the corresponding list according to a specific standard to generate data clusters. These data clusters are grouped to form a cluster sequence.

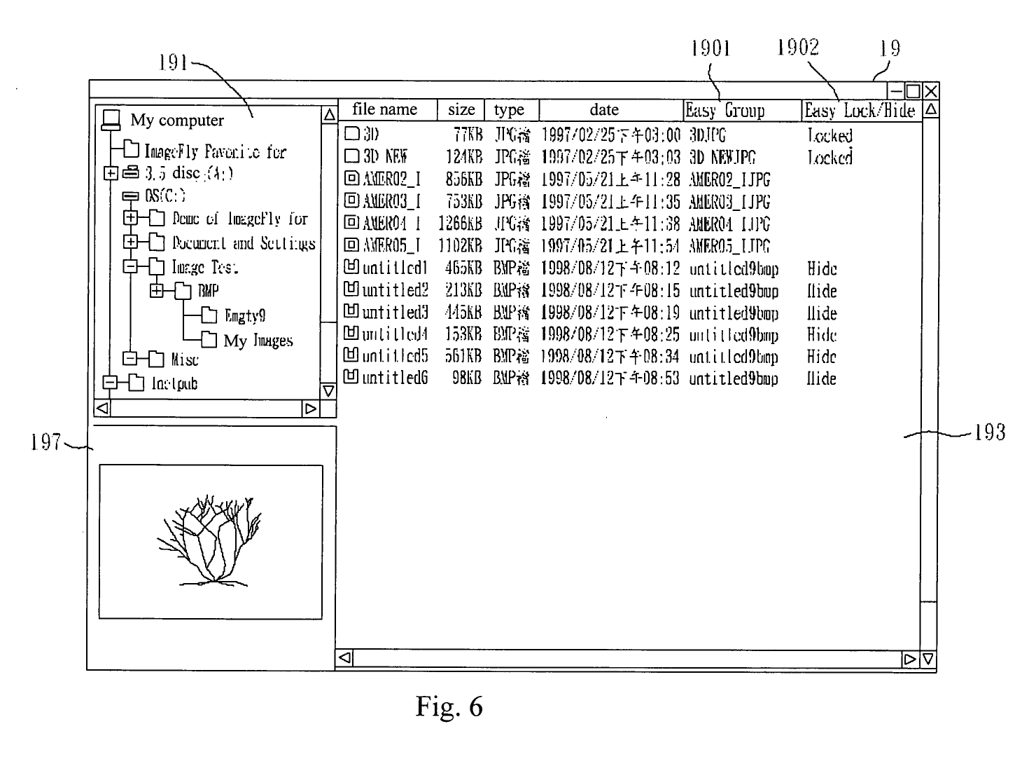

In accordance with the present invention, a cluster is composed of a data listed in the destination. Or, a cluster is composed of a plurality of data listed in the destination and with a common defining characteristic. When a new cluster is generated, this cluster is given a name that may be composed of the first file name and the type name as indicated by the reference number 1901 in FIG. 6. The defining characteristic of the grouping module 13 may be the file name, file type, file size or date of the data file.

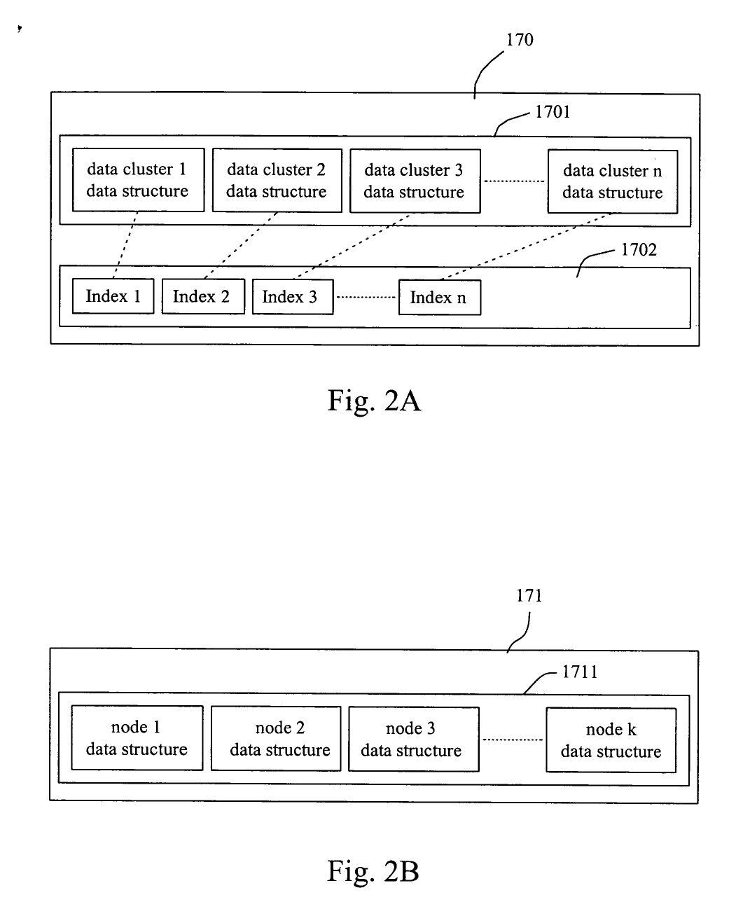

For conveniently classifying and managing the data file, the storage means 17 stores at least one cluster sequence file 170 to correspond to a destination and a destination structure file 171 to correspond to a destination structure. FIG. 2A illustrates a cluster sequence file. This cluster sequence file 170 includes the data structure among the data clusters and in the data cluster. Therefore, the cluster sequence file 170 includes a first data group 1701 and a second data group 1702. The first data group 1701 is used to record the data structure of each data cluster. In this embodiment of the present invention, the data structure of each data cluster includes the cluster name, the cluster representative figure, the path of each data file in the cluster, the name of each data in the cluster, the size of each data file in the cluster, the date of each data file in the cluster, the thumbnail of each data file in the cluster, the represented file in the cluster or the type of the cluster. The type of the cluster includes whether the cluster is selected, hidden or locked.

The second data group 1702 records the data cluster referred to by the cluster sequence. The second data group 1702 includes a plurality of indexes. Each index refers to a data structure of a data cluster in the first data group 1701.

FIG. 2B illustrates a destination structure file. The destination structure file 171 stores a data structure of a destination structure. This data structure includes a third data group 1711. The third data group 1711 records the data structure of nodes, including the destination nodes, of the destination structure. The destination nodes are the destination of the destination structure when the system is activated again. The data structure of each node includes the reference number of the node, the reference number of the main node, the name of the node, the type of node and the corresponding list or data file address. The node type is used to indicate whether or not the node is a destination node.

The management module 11 responds to a user management requirement inputted from the user interface. The data clusters are classified and managed according to the user requirement. The requirement involves a cluster mergence action and release action. For example, one cluster, many clusters or a partial cluster selected by a user may be directly merged to another cluster in the cluster mergence action or released from another cluster in the cluster release action. In other words, according to the present invention, it is not necessary to create any new destination before performing the cluster mergence action and release action. Moreover, the content of the cluster sequence file 170 is renewed when the data structure existing among clusters or in the cluster is changed.

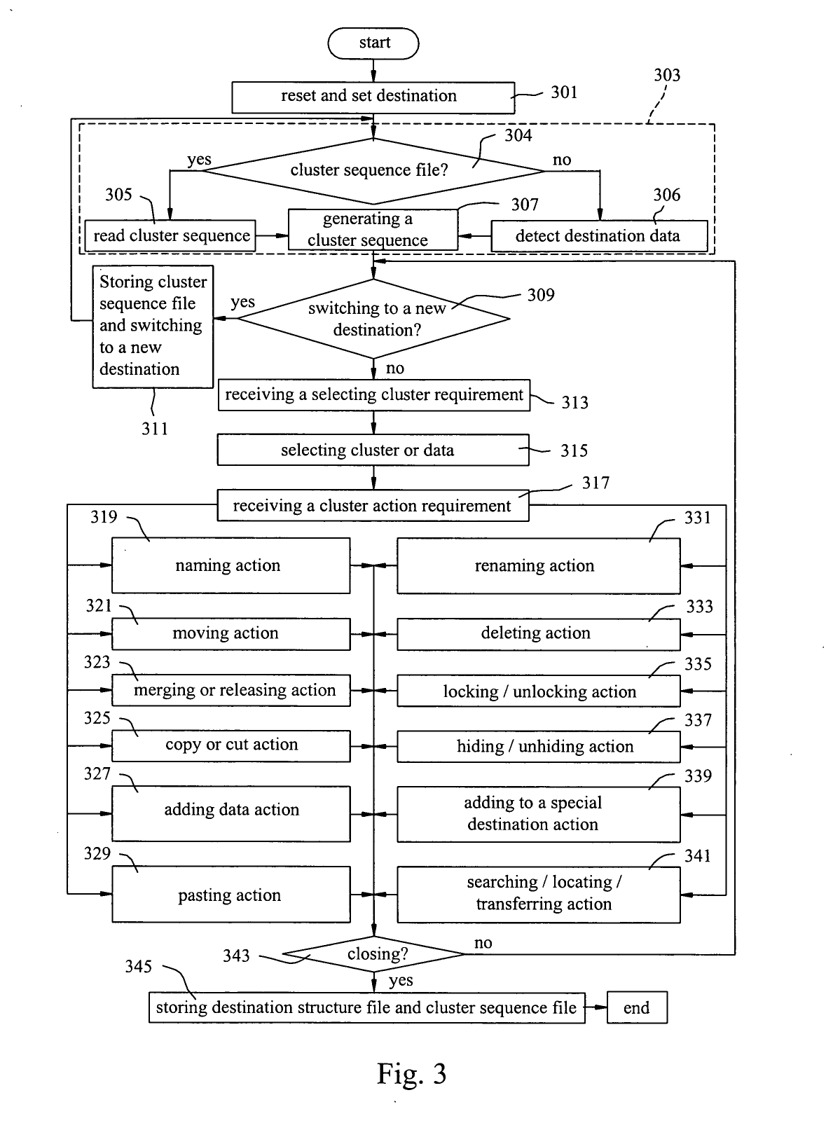

FIG. 3 illustrates a flow chart according to the preferred embodiment of the present invention. First, a computer system is reset; then, a destination is set in step 301 to create a user interface and tree structure destination and set the destination. Next, in step 303, a cluster sequence is generated. The step 304 is for determining whether or not the storage means has stored the cluster sequence file corresponding to the destination. If the cluster sequence file is in the storage means the system of the embodiment reads this cluster sequence file in step 305. If the cluster sequence file is not in the storage means the system of the embodiment detects data files of the destination list in step 306. Then, in step 307, if the cluster sequence file exists, the grouping module generates a cluster sequence according to the data structure recorded in the cluster sequence file. On the other hand, if the cluster sequence file does not exist, the grouping module generates a new cluster sequence according to the pre-defined characteristic.

Next, a determining step 309 is performed. The step 309 whether or not a user wants to change the destination. The step 311 is performed If the user determines to change the destination, the destination is switched to the new destination after the data structure existing among data clusters or in the data clusters of the corresponding destination is stored into a cluster sequence file by the construction module 15. On the other hand, if the user determines that the destination is not changed a requirement of selecting the cluster or the data stored in the cluster from the user is received in step 313. After receiving the requirement, selecting data in the cluster or clusters is performed in step 315. It is noticed that the selecting method used in Windows products is a well-known technology for one skilled in the art. Next, the cluster action requirement from a user is received in step 317. The provided cluster action is described in the following.

The “cluster naming action”, step 319, provides a user the ability to name a cluster. For example, the user may activate a dialog window and input a name for a cluster via keyboard input. The “cluster position movement action”, step 321, provides a user the ability to move a cluster or a plurality of clusters together. The user may use the cursor to select a cluster or clusters and then drag and drop the selected to another cluster.

The “cluster mergence and release action”, step 323, provides the selected cluster, clusters or any data stored in any clusters to merge with or release from each other directly. The merge or release method is described in the following.
a. A user may use a cursor to drag the selected and drop them to another objective cluster or data. In other words, the selected are merged to the objective cluster or data.
b. A user may use menu or keyboard to merge the selected to form a new cluster.
c. A user may use menu or keyboard to release the selected to become a separate cluster, clusters or a new cluster.

It is noticed that the objective cluster may be a cluster located in another destination cluster sequence. For example, the selected data and the objective cluster may be respectively located in different windows.

The “data cluster copying and cutting action”, step 325, provides a user the ability to move or copy at least one data cluster or data in clusters without breaking their data structure. The copying or cutting method is described in the following.

A. A user selects a new destination, for example: a list or a web page, through a dialog window, a cursor or other well-known input method. Then, this user may use the following method to copy or cut the clusters to the new destination.
1. The selected data are copied or cut to the new destination. If a data existing in the new destination, a recognized name, such as a number, is given to the data. The number is appended to the data name to present the selected number.
2. A new sub-destination, such as a sub-catalog, is automatically generated. All the selected data are copied or cut to the new sub-destination.
3. Each selected data cluster correspondingly generates a new sub-destination, such as a sub-catalog, automatically. Each data cluster is copied or cut to the corresponding sub-destination.
4. The new sub-destination is automatically attributed the name of the corresponding cluster (described in the foregoing item 3) or the name of one of the selected data clusters (described in the foregoing item 2).
5. If the name of new sub-destination already exists, a recognized number is appended to distinguish.

B. The user may also use keys (such as a Ctrl key and a C key) or a menu to copy the selected data.

C. The selected data are also copied or cut to different cluster sequences.

The “adding an additional data action”, step 327, provides a user the ability to add additional data to a selected data cluster or to form a new data cluster. The user may use any well-known selection method (such as using a cursor, a menu or keys) to perform this step. The additional data is data located in another destination, such as located in a digital camera, in a scanner, in a web page, in another list and so on. The user can set a rule to automatically name the additional data. The additional data is added to a cluster and is sequentially arranged following the original data in this cluster.

The “adhering a copied or cut data cluster action”, step 329, provides a user the ability to adhere the selected data of clusters to a destination without breaking the data structure of the selected.

The “renaming in clusters action”, step 331, provides a user the ability to set a prefix to all data in clusters. For example, the user may set a prefix that is composed of the strings “Natural”, “Event”, “Human” and so on. Then, a well-known prior art method is used to rename all data located in a cluster.

The “deleting clusters action”, step 333, provides a user the ability to delete clusters or data in clusters. The data or clusters may be selected and then deleted by using a cursor, a menu, or any well-known method. When a cluster is deleted, the data located in this cluster are also deleted.

The “locking and unlocking clusters action”, step 335, provides a user the ability to lock or unlock a cluster or clusters. Locking a cluster is done to limit data being deleted from or added into the cluster, until the cluster is unlocked. The user may use any well-known method to select clusters to lock or unlock. If the cluster is a picture cluster, a small graph is shown beside the picture cluster to tell the user the cluster is locked. Conversely, this small graph is removed when this cluster is unlocked. If the cluster is a text cluster, locked information is shown in a column, such as that shown in an “Easy Lock/Hide” column 1902 in FIG. 6.

The “hiding or un-hiding a cluster action”, step 337, provides a user the ability to hide or un-hide a cluster. The user can use the following method to hide a selected data cluster.
a. The user may hide a selected data cluster or clusters through using a menu or keyboard.
b. The user may use a cursor and menu to hide a data cluster.

Similarly, the user can use the following method to un-hide a cluster to re-show this cluster in the display.
a. The user may un-hide all hidden clusters through using a menu action, such as “Show All”.
b. The user may un-hide a selected data cluster that's is selected by a cursor through using a menu action, such as “Show Position”.

If the data cluster is with a text display, hidden information is shown in a column, such as that shown in an “Easy Lock/Hide” column 1902 in FIG. 6.

The “adding data cluster to a special destination action”, step 339, provides a special destination for a user to manage data among different destinations. Physical data is not stored in the special destination. Therefore, the “paste” function, “copy” function and “delete” function may not be performed in this special destination. However, the “rename” function, “select” function, “hide” function and “lock” function may be performed. A user may select data clusters anywhere (for example: C-disk, D-disk and so on) to put into the special destination without changing the data structure of the selected data clusters. A well-known method may be used to put the data clusters into the special destination.

The “searching/locating and transferring the data cluster action”, step 341, provides a user the ability to search/locate and transfer the data cluster in a destination. Searching and locating are used to search for and locate a specific data cluster. When a specific data cluster is searched for and located, the user may use a well-known method to switch to the destination of the specific data cluster. The transferring function is used to transfer clusters or cluster's data in any destination through the Internet.

After any one of the foregoing steps, step 319 to step 341, is performed, a determining step is performed to determine whether or not the data classifying and management has been finished in step 343. If the data classification and management has been finished, the destination structure file and the cluster sequence file related to the destination are stored in step 345, otherwise, the flow will go back to the step 309.

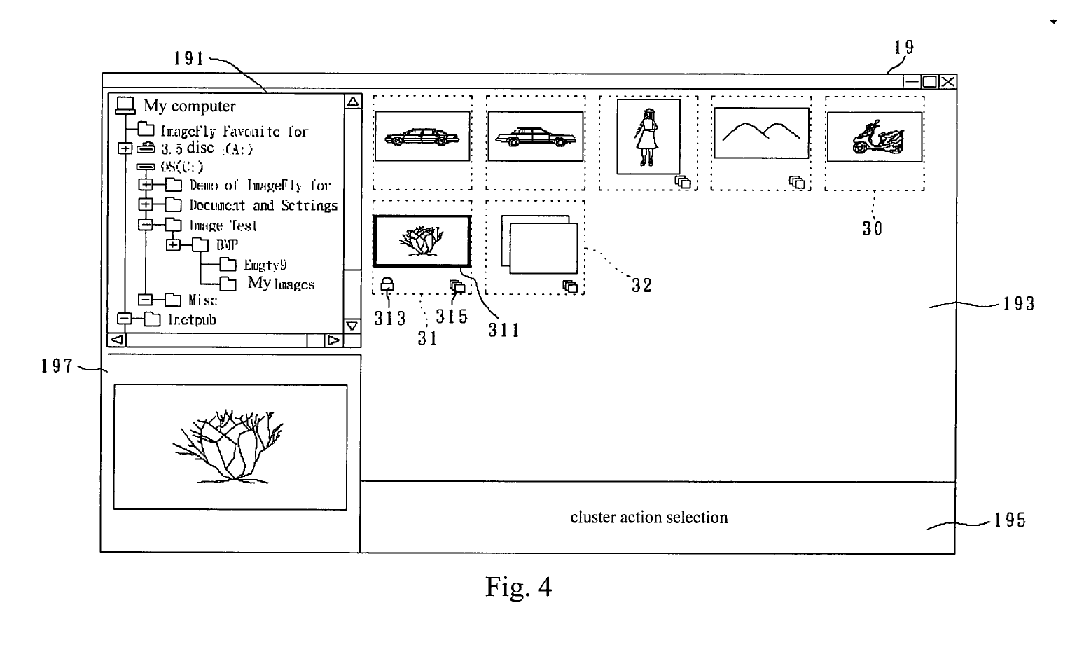

The display of the data cluster may be text, a graph or a composition of text and graph. FIG. 4 illustrates the graphical display of the data clusters. FIG. 6 illustrates the textual display of the data clusters.

In FIG. 4, the user interface 19 includes a destination structure column 191, a cluster sequence column 193, a selecting cluster action column 195 and a preview column 197. The destination structure column 191 shows the tree structure of the destination generated by the construction module 15. The cluster sequence column 193 shows the data clusters generated by the grouping module 13. The selecting cluster action column 195 provides a user some function items to operate the data clusters. The preview column 197 shows a representative picture (for example: figure, icon and so on) of the selected cluster. The representative picture is the first picture of the selected cluster.

In FIG. 4, the display of the data cluster includes a representative picture 311 and a small picture 315 if at least two pictures in the data cluster as shown are the data cluster 31. In other words, a small picture 315 is not shown if only one picture is stored in the data cluster as shown by the data cluster 30. Moreover, text may also be added in the data cluster display. The data cluster 31 is locked; therefore a key diagram 313 is displayed in the data cluster 31 for recognition. When a data cluster is selected, the display of this selected data cluster is changed. For example, a border 311 is added or a different color is displayed as shown by the data cluster 31. In comparison, when a data cluster is hidden, the representative picture is also hidden as shown by the data cluster 32.

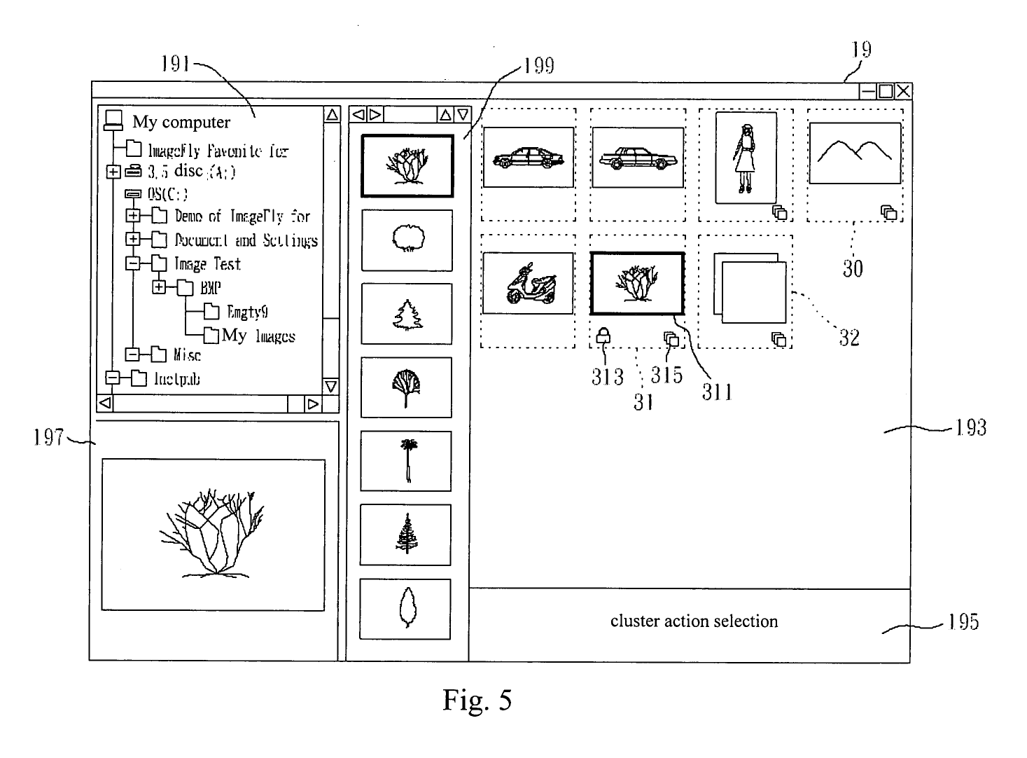

The user interface 19 in FIG. 5 further includes a stack column 199, which is used to show the content of a selected data cluster. The stack column 199 may help a user to select the specific data stored in the data cluster. For example, a user may select the data for merging, releasing, copying or cutting. It is easy to change the cluster position in the user interface in FIG. 4. The user interface in FIG. 4 is called a normal mode user interface. The user interface in FIG. 5 is called a stack mode user interface. When using a cursor to drag and drop, the normal mode is set to perform the cluster position changing action, the stack mode is set to perform the cluster copying, deleting or merging actions. However, when using cursor and a specific key to drag and drop, the normal mode is set to perform the cluster copying, deleting or merging actions; the stack mode is set to perform the cluster position changing action.

The present invention has the following advantages.
1. Many selecting data methods are provided to a user.
2. The selected data may be directly merged with and separated from each other. It is not necessary to create a destination first
3. The cluster mergence and release can be directly performed among data cluster sequences.
4. The cluster structure of the classified data clusters is kept the same when these data clusters are copied, cut, pasted and positioned in a destination. In other words, the classification result is maintained. Therefore, it is not necessary to rearrange these classified data clusters.
5. The searching, locating and transferring actions may be performed among different destinations, such as C-disk, D-disk, E-disk and so on, once at same time.

The foregoing embodiment can be presented differently by various modifications or arrangements, for example:

A different software module, such as MVC (model, view, control) design and so on, may be used to construct the system.

A different arrangement of the data structure may be used as following example:
1. The different storage structure, such as the destination structure file and cluster sequence file may be merged into a file, or don't save destination structure to a file.
2. The different arrangement and cutting method, such as all thumbnails of files can be accessed independently and so on.
3. The different index reference method, such as index reference of all thumbnails may be added into the system and so on.
4. The data structure can be further simplified, such as the file name and the file date can be excluded from the data structure of the cluster and so on.

A different structure type, such as a menu type, tree type, net type and so on, of the destination structure or cluster sequence may be used.

A different arrangement of the user interface may be used. For example, the selection action and the drag-drop action may be merged into a single action and so on.

The destination may be different according to the application, especially for logic object. For example, the destination may be a picture cabinet, a medium cabinet, a fingernail cabinet or an album and so on. The reference object may be a picture clip file, a medium clip file, a fingernail clip file or a photo file. And then, constructing module and user interface will provide user to create, delete or rename a destination.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

1. A data classification management system in a computer system, comprising:
a constructing module for generating a destination structure, wherein said destination structure is a set composed of destination, said destination is a list, file or data;
a grouping module for generating a cluster sequence in said destination according to a cluster sequence file related to said destination or a specific condition, wherein said cluster sequence is a set composed of data cluster, said data cluster is a set composed of data;
a storage means for storing a data structure of said cluster sequence to a said cluster sequence file; and
a management module for managing said cluster sequence according to a cluster action requirement and synchronously renewing said cluster sequence.

2. The system of claim 1, wherein said specific condition is a predefined condition.

3. The system of claim 2, wherein said predefined condition is data name, data style, data size or data date.

4. The system of claim 1, wherein said data structure of said cluster sequence comprises two data sets, one data set composed of data structure of data cluster in said cluster sequence, the other data set composed of indexes which refers to data structure of data cluster in said cluster sequence.

5. The system of claim 4, wherein said data structure of said data cluster is a cluster name, data address, data name, data size, data date, data thumbnail, cluster representative data, cluster representative figure or cluster state.

6. The system of claim 5, wherein said cluster state can be selected, hidden or locked.

7. The system of claim 1, wherein said storage means further stores a destination structure file that includes a data structure of said destination structure.

8. The system of claim 7, wherein said destination structure comprises a data set to record the data structures of all nodes that at least include a destination node.

9. The system of claim 8, wherein said data structure of a destination node comprises a node number, a main node number, a node name, a node type, and a list position or data address corresponding to a node.

10. The method of claim 1, wherein after said grouping module generating a cluster sequence in said destination further comprises:
storing a data structure of said cluster sequence to a cluster sequence file or switching to another destination in said destination structure.

11. The system of claim 1, wherein said system further comprises a user interface for responding to the action requirement and displaying the processing result.

12. The system of claim 11, wherein said user interface comprises:
a destination structure column for displaying destination structures;
a cluster sequence column for displaying data clusters in cluster sequence; and
a cluster action selection column for selecting a cluster action.

13. The system of claim 12, wherein each said data cluster is displayed using textual or a graphical figure in said cluster sequence column.

14. The system of claim 13, wherein said graphical figure include a representative figure of said data cluster.

15. The system of claim 12, wherein said user interface further comprises a stack column for displaying the content of data cluster.

16. The system of claim 12, wherein said user interface further comprises a preview column for displaying a representative figure of selected data cluster in said cluster sequence.

17. The system of claim 1, wherein said cluster action requirement comprises a data cluster naming action, a moving action, a merging action, a releasing action, a copying action, a cutting action, a deleting action, a locking action, an unlocking action, a hiding action or an un-hiding action.

18. The system of claim 17, wherein said data cluster merging action is to directly merge the selected data in clusters to an object data cluster or object data.

19. The system of claim 18, wherein said selected data in clusters and said object data cluster or data are located in the same cluster sequence or different cluster sequences.

20. The system of claim 17, wherein said data cluster releasing is to release the selected data in clusters to form one or a plurality of data clusters or data.

21. The system of claim 17, wherein said data cluster copying or cutting is to copy the selected data in clusters to a new destination while maintaining the data structure of said selected data in clusters.

22. The method of claim 17, wherein said data cluster copying or cutting is to copy the selected data in clusters to a new generated suffix-destination of the new destination while maintaining the data structure of said selected data in clusters

23. The system of claim 17, wherein said data cluster copying or cutting action may copy data in different cluster sequences.

24. The system of claim 17, wherein said data cluster naming action is to name the data in a data cluster according to a naming rule or cluster name.

25. The system of claim 17, wherein said moving action is to move a cluster or a plurality of clusters together.

26. The system of claim 17, wherein said deleing action is to delete clusters or data in clusters.

27. The system of claim 17, wherein said locking or un-locking action is locking a cluster or clusters for limiting data being deleted from or added into, until the cluster is unlocked.

28. The system of claim 17, wherein said hiding or un-hiding action is provides a user the ability to hide or un-hide data clusters.

29. The system of claim 1, wherein said constructing module may create, rename or delete a destination.

30. The system of claim 1, wherein said cluster action further comprises adding an additional data action, said additional data is the data outside said cluster sequence, and may be added into a selected data cluster or may generate a new data cluster in said cluster sequence.

31. The system of claim 1, wherein said destination structure further includes a set composed of special destination.

32. The system of claim 1, wherein said cluster action further comprises adding to a special destination action, said adding to a special destination is add the selected clusters which are outside special destination to said special destination without changing the data structure of the selected clusters.

33. The system of claim 1, wherein said cluster action further comprises search or locating action, said search or locating action is searching said special destination to found specific cluster, and may switch to the destination of said specific cluster.

34. The system of claim 1, wherein said cluster action further comprises transferring the selected data in clusters through the Internet.

35. The system of claim 1, wherein said cluster action requirement may be inputted through a keyboard coupled to said computer system, a menu provided by said computer system, a mouse or device controlling cursor coupled to said computer system.
